(19) United States
(12) Patent Application Publication
(10) Pub. No.: US 2007/0191039 A1
(43) Pub. Date: Aug. 16, 2007

(54) Method for replying to message in wireless portable terminal

(75) Inventor: Hyung-Hoon Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/654,364

(22) Filed: Jan. 17, 2007

(30) Foreign Application Priority Data
Jan. 17, 2006 (KR) 10-2006-0004950

(51) Int. Cl. H04Q 7/20

(52) U.S. Cl. 455/466

(57) ABSTRACT

A method for replying to a message in a wireless portable terminal is disclosed that makes it possible to provide various types of reply information in the message mode, and to prevent the abuse of reply information. In such a method, reply information is input utilizing a character set in the message mode, the reply information input by converting the character set is into specific values, and a message containing the reply information consisting of the specific values is sent. Also, if a reply number is input in the message mode, authentication for the input reply number is requested to a server and, if an authentication grant for the reply number is received from the server, a message containing the authenticated reply number is sent.

### PRIORITY

This application claims priority to applications entitled “Method for Replying to Message in Wireless Portable Terminal” filed in the Korean Industrial Property Office on Jan. 17, 2006 and assigned Serial No. 2006-0004950, the contents of which are incorporated herein by reference.

### BACKGROUND OF THE INVENTION

1. Field of the Invention

The present invention relates to a method for replying to a message in a wireless portable terminal, and more particularly to a method for replying to a message in a wireless portable terminal, which makes it possible to provide various types of reply information in the message mode of the wireless portable terminal, and to prevent abuse of reply information.

2. Description of the Related Art

A typical wireless portable terminal is aimed at only sending voice information to a counter party, but technical developments make it possible for a user to make use of a message service when using a wireless portable terminal. The message service may be classified into a Short Message Service (SMS) and a Long Message Service (LMS) and, in addition, a Multimedia Message Service (MMS). This classification is not only based on the number of inputtable characters, but is also based on whether multimedia-related pictures or moving images are contained in a message.

When a message is sent using such a message service, a user inputs message contents, a called party number which is a destination of the message, and reply information, and then sends the message to the called party number. The reply information is a number to which the called party of the message can send a reply to the message.

However, a shortcoming exists in that only a number is input as the reply information through a numeral input, and other characters or special symbols cannot be used. In other words, the reply information is a reply number.

Also, a calling party number is input when originating the message, that is, a number to which a reply to the message can be received, is input as the reply number. However, there are some cases where people abuse the reply number by inputting and sending a number that is different from the calling party number.

### SUMMARY OF THE INVENTION

Accordingly, the present invention has been made to solve at least the above-mentioned problem occurring in conventional systems, and an object of the present invention is to provide a method for replying to a message in a wireless portable terminal, by which various types of information other than numerals can be provided as reply information in the message mode of the wireless portable terminal.

A further object of the present invention is to provide a method for replying to a message in a wireless portable terminal, which can prevent the abuse of reply information in the message mode of the wireless portable terminal.

To accomplish these objects, in accordance with an aspect of the present invention, there is provided a method for replying to a message in a wireless portable terminal, the method includes inputting reply information utilizing a character set in a message mode of the wireless portable terminal; converting the reply information input into specific values; and sending a message containing the reply information consisting of the specific values.

In accordance with another aspect of the present invention, there is provided a method for replying to a message in a wireless portable terminal, the method includes if a reply to a received message is selected in the wireless potable terminal, switching the wireless portable terminal to a reply mode; if sending is selected after message contents are written in the reply mode, analyzing reply information of the received message; and if the reply information consists of a character set, sending a message to a phone number of a terminal that sent the received message.

In accordance with still another aspect of the present invention, there is provided a method for replying to a message in a wireless portable terminal, the method includes if a reply number is input in a message mode of the wireless portable terminal, requesting a server to authenticate the input reply number; and if an authentication grant for the reply number is received from the server, sending a message containing the authenticated reply number.

In accordance with still yet another aspect of the present invention, there is provided a method for replying to a message in a wireless portable terminal, the method includes if a reply to a received message is selected in the wireless portable terminal, switching the wireless portable terminal to a reply mode; if sending is selected after message contents are written in the reply mode, comparing a phone number of a terminal, which sent the received message, with a reply number contained in the received message; and if the phone number of the terminal is not the same as the reply number, sending a message to either the phone number of the terminal, which sent the received message, or the reply number.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a structure of a wireless portable terminal in accordance with the present invention;

FIG. 2 is a flowchart illustrating a procedure of inputting reply information in the message mode of a wireless portable terminal in accordance with the present invention;

FIG. 3 is a flowchart illustrating a procedure of replying to a message through a reply character set/reply number in a wireless portable terminal in accordance with the present invention;

FIG. 4 is a flowchart illustrating a procedure of authenticating a reply number in the message mode of a wireless portable terminal in accordance with the present invention; and

FIG. 5 is a flowchart illustrating a procedure of replying to a message through a phone number or a reply number in a wireless portable terminal in accordance with the present invention.

### DETAILED DESCRIPTION OF THE PREFERRED EMBODIMENTS

Hereinafter, preferred embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

In the embodiments of the present invention, reply information will be illustratively described as being input utilizing a character set/numeral input. It will be recognized that a special symbol input may also be applied in addition to the character set/numeral input.

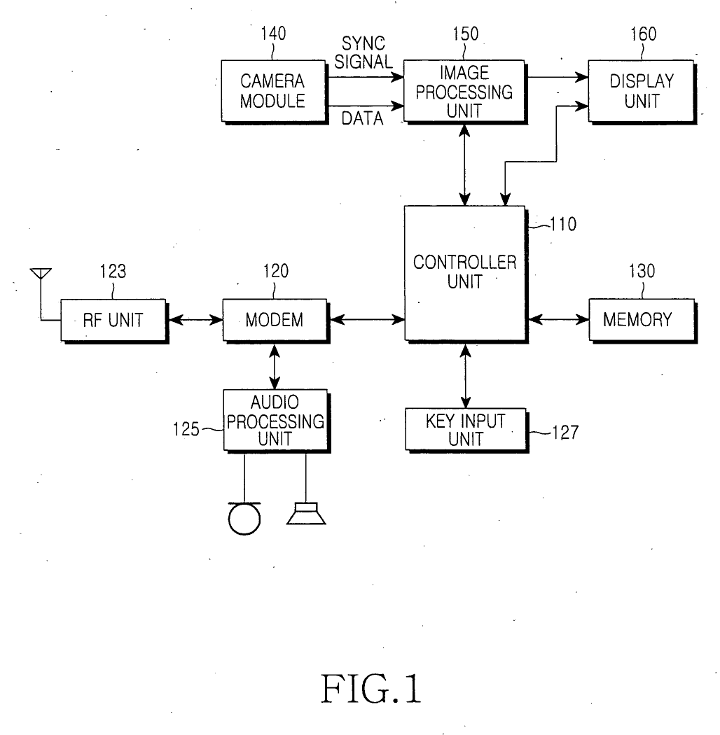

FIG. 1 illustrates the structure of a wireless portable terminal according to the present invention. Referring to FIG. 1, an RF unit 123 performs wireless communication functions of the wireless portable terminal. The RF unit 123 includes an RF transmitter for converting the frequency of a transmitted signal to a higher frequency and then amplifying the frequency-converted signal, an RF receiver for low noise-amplifying a received signal and then converting the frequency of the amplified signal to a lower frequency, and so forth. A modem 120 includes a transmitter for encoding and modulating the transmitted signal, a receiver for demodulating and decoding the received signal, and the like. An audio processing unit 125 can configure a codec, and the codec includes a data codec for processing a data signal such as packet data, and an audio codec for processing an audio signal such as voice. The audio processing unit 125 functions to convert a digital audio signal, which the modem 120 receives, into an analogue audio signal through the audio codec and reproduce the converted analogue audio signal, or to convert an analogue audio signal, which is generated and transmitted from a microphone, into a digital audio signal through the audio codec and transmit the converted digital audio signal to the modem 120. The codec may be separately provided or may be included in a controller unit 110.

A memory 130 may consist of a program memory and a data memory. The program memory may store programs for controlling general operations of the wireless portable terminal and programs for controlling to diversify message reply information and to prevent the abuse of reply information according to the present invention. The data memory functions to temporarily store data occurring in executing the control programs. The memory 130 may also store a table containing specific code values, for example, ASCII code values or HEXA code values, which are mapped to numerals corresponding to a reply character set. The memory 130 further stores the phone number of a terminal which sent a corresponding received message and reply information (a reply character set/reply number) contained in the received message. According to the present invention, the memory 130 further stores a reply number authenticated from a server.

The controller unit 110 functions to control the overall operations of the wireless portable terminal. The controller unit 110 may also include the modem 120 and the codec. According to the present invention, the controller unit 110 converts a reply character set, which is input as reply information in the message mode of the wireless portable terminal, into specific code values, and sends a message containing the reply character set consisting of the specific code values. The controller unit 110 sends a reply message to the phone number of a terminal which sent a received message, if reply information contained in the received message is a character set when a reply message to the received message is sent.

The controller unit 110 inputs only a reply number, to which a server grants authentication, as reply information in the message mode. The controller unit 110 selectively sends a reply message to the phone number of a terminal which sent a received message or to a reply number contained in the received message when the reply message to the received message is sent.

A camera module 140 includes a camera sensor for photographing image data and converting an optical signal of the photographed image data into an electrical signal, and a signal processor for converting an analogue image signal, which is photographed by the camera sensor, into digital data. Here, the camera sensor is assumed to be a CCD sensor, and the signal processor may be implemented as a Digital Signal Processor (DSP). Also, the camera sensor and the signal processor may be integrally or separately implemented.

An image processing unit 150 functions to generate image data for displaying an image signal output from the camera module 140. The image processing unit 150 processes the image signal from the camera module 140 on a frame-by-frame basis, and outputs frame image data coincidentally with the characteristics and the size of a display unit 160. The image processing unit 150 also has an image codec, and functions to compress frame image data to be displayed on the display unit 160 according to a preset scheme or restore the compressed frame image data to the original frame image data. Here, the image codec may be a JPEG codec, a MPEG4 codec, a Wavelet codec, etc. Assuming that the image processing unit 150 is provided with an On Screen Display (OSD) function, the image processing unit 150 may output OSD data according to the screen size under the control of the controller unit 110.

The display unit 160 displays an image signal output from the image processing unit 150, and displays user data output from the controller unit 110. Here, an LCD may be used as the display unit 160 and, in this case, the display unit 160 may have an LCD controller, a memory capable of storing image data, and an LCD display device, and so forth. When the LCD is implemented in a touch screen type, the LCD may operate as an input unit. According to the present invention, the display unit 160 may also display reply information input by means of a character set in the message mode.

A key input unit 127 has keys for inputting numeral and character information, and various function keys for setting a variety of functions.

Hereinafter, procedures of replying to a message in the above-mentioned wireless portable terminal will be described with reference to FIGS. 1 to 5.

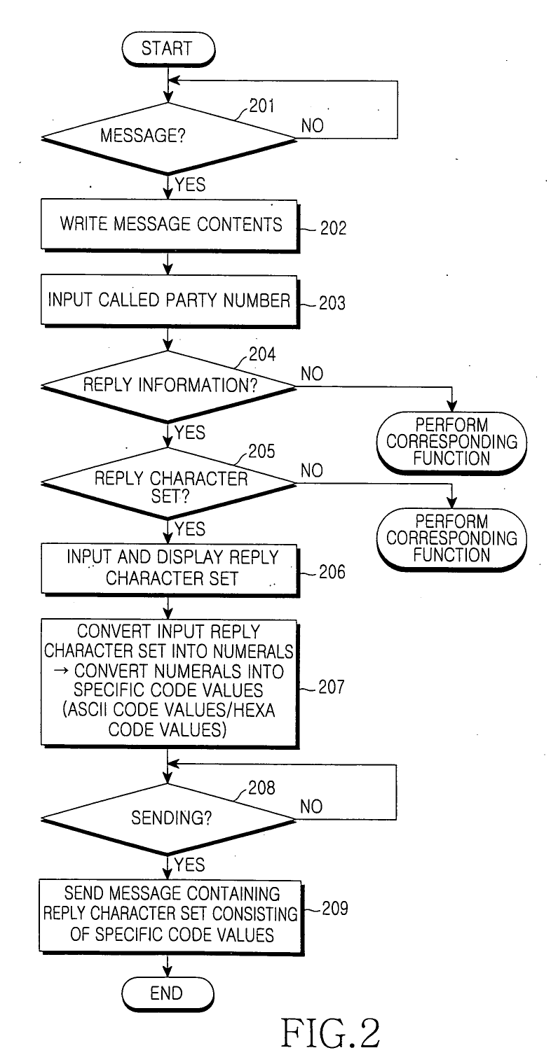

FIG. 2 is a flowchart illustrating a procedure of inputting reply information in the message mode of the wireless portable terminal according to the present invention. Referring to FIG. 2, if a message is selected in the wireless portable terminal, the controller unit 110 detects this in step 201 and switches the wireless portable terminal to the message mode. If reply information is selected after message writing is selected in the message mode to write message contents in step 202 and a called party number is input in step 203, the controller unit 110 detects this in step 204 and switches the terminal to the reply information input mode. If a reply character set is selected in the reply information input mode, the controller unit 110 detects this in step 205 and proceeds to step 206 to display a reply character set input by a user in a reply information column. The length of the reply character set input in the reply information column may be restricted.

The controller unit 110 then proceeds to step 207 to covert the reply character set input in step 206 into specific code values. In step 207, the controller unit 110 converts the input reply character set into numerals corresponding thereto, and then converts the numerals into ASCII code values or HEXA code values. The numerals are numerals marked on keys of key input unit 207 which the user presses in order to input the reply character set, and are numerals displayed on the screen when the same kinds of keys as those used for the reply character set input are pressed an appropriate number of times.

For example, if the reply character set is input as “puroon” (a Korean adjective meaning “blue”), the controller unit 110 converts the character set “puroon” into numerals “77325535”, and then converts the numerals “77325535” into ASCII code values “0x37, 0x37, 0x33, 0x32, 0x35, 0x35, 0x33, 0x35” or HEXA code values “0x07, 0x07, 0x03, 0x02, 0x05, 0x05, 0x03, 0x05”.

If message sending is selected after completion of converting the reply character set into specific code values in step 207, the controller unit 110 detects this in step 208 and proceeds to step 209 to send a message containing the reply character set consisting of the specific code values to the caller party number.

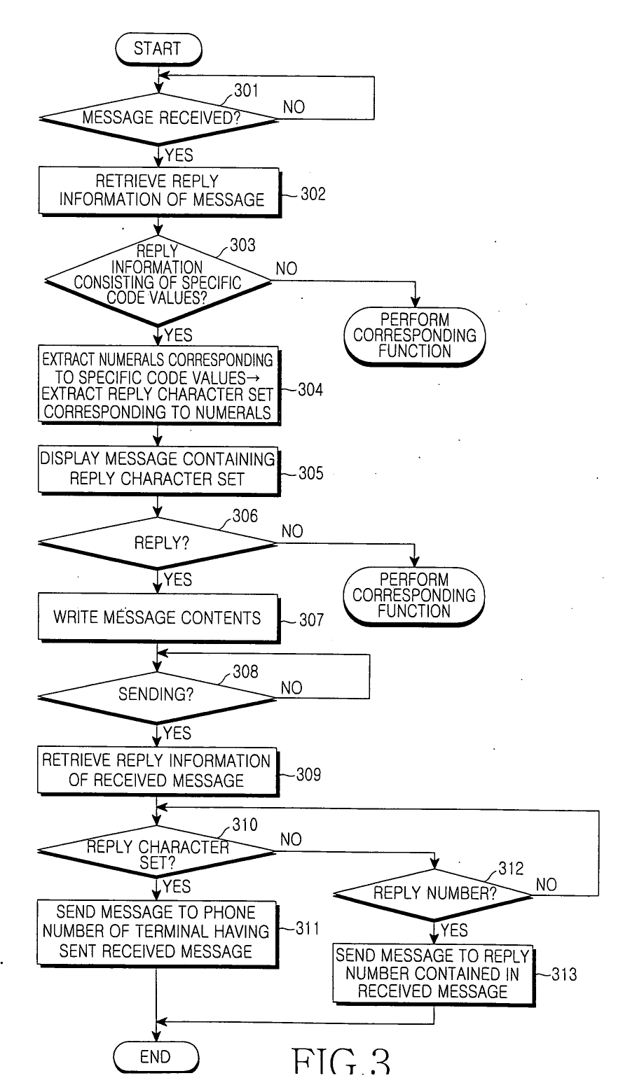

FIG. 3 is a flowchart illustrating a procedure of replying to a message through a reply character set/reply number in the wireless portable terminal according to the present invention. Referring to FIG. 3, if a message is received by the wireless portable terminal, the controller unit 110 detects this in step 301 and proceeds to step 302 to retrieve reply information contained in the received message. When a result of the reply information retrieval shows that the reply information consists of specific coded values, the controller unit 110 detects this in step 303 and proceeds to step 304 to extract a reply character set from the specific code values. In step 304, the controller unit 110 extracts numerals corresponding to the specific code values by using the table stored in the memory 130, and further extracts a reply character set corresponding to the extracted numerals. The controller unit 110 also stores the extracted reply information and the phone number of a terminal having sent the corresponding received message in the memory 130. The controller unit 110 proceeds to step 305 to display the message including the extracted reply character set on the screen.

If a reply to the received message is selected, the controller unit 110 detects this in step 306 and proceeds to step 307 to switch the terminal to the message writing mode. If sending is selected after completion the message writing in step 307, the controller unit 110 detects this in step 308 and proceeds to step 309 to retrieve the reply information of the received message.

When a result of the reply information retrieval shows that the reply information is a reply character set, the controller unit 110 detects this in step 310 and proceeds to step 311 to send a reply message to the phone number of the terminal which sent the receive message stored correspondingly to the reply information.

However, when a result of the reply information retrieval shows that the reply information is a reply number, the controller unit 110 detects this in step 312 and proceeds to step 313 to send the reply message to the reply number of the received message.

As described above and as illustrated in FIGS. 2 and 3, various reply information can be input and displayed in the message mode using procedures of character set input as well as numeral input, and a reply message can be sent based on the reply information.

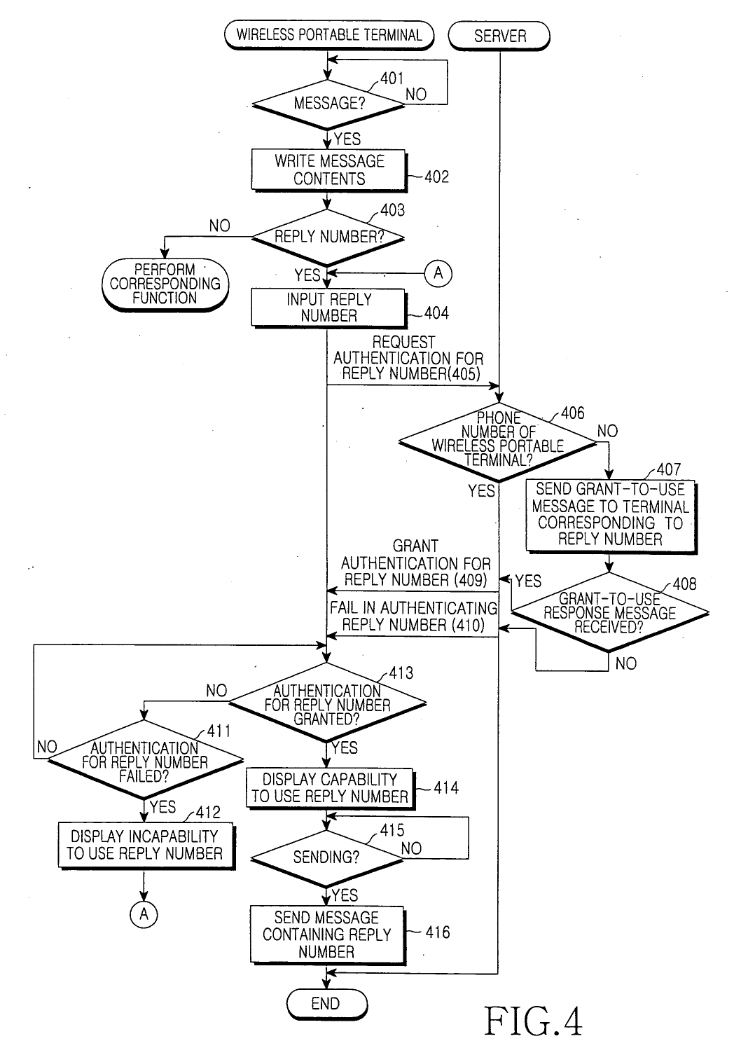

FIG. 4 is a flow chart illustrating a procedure of authenticating a reply number in the message mode of the wireless portable terminal according to the present invention. Referring to FIG. 4, if a message is selected in the wireless portable terminal, the controller unit 110 detects this in step 401 and switches the wireless portable terminal to the message mode.

If message writing is selected in the message mode to write message contents in step 402, and then a reply number is selected, the controller unit 110 detects this in step 403 and proceeds to step 404 to switch the terminal to the reply number input mode. If the reply number is input in the reply number input mode, the controller unit 110 detects this and proceeds to step 405 to send the input reply number to a server in order to request that the server authenticate the reply number.

The server, which receives the authentication request for the reply number from the wireless portable terminal, determines whether the received reply number is the wireless portable terminal's own phone number. If the received reply number is the wireless portable terminal's own number, the server detects this in step 406 and proceeds to step 409 to send a message, which informs authentication grant for the reply number, to the wireless portable terminal.

However, if the received reply number is not the wireless portable terminal's own number, the server detects this in step 406 and proceeds to step 407 to send a grant-to-use message to a terminal possessing the corresponding phone number which is a target of the requested authentication.

If a grant-to-use response message is received from the terminal possessing the corresponding phone number, the server detects this in step 408 and proceeds to step 409 to send a message, which informs authentication grant for the reply number, to the wireless portable terminal. However, if a response message is not received for a certain period of time or a grant-to-use response message is not received from the terminal possessing the corresponding phone number, the server detects this in step 408 and proceeds to step 410 to send a message, which informs of a failure in authenticating the reply number, to the wireless portable terminal.

If the message informing of a failure in authenticating the reply number input in step 404 is received from the server, the controller unit 110 detects this in step 411 and proceeds to step 412 to display the fact that it is impossible to use the reply number.

However, if the message informing the authentication grant for the reply number is received from the server, the controller unit 110 detects this in step 413 and proceeds to step 414 to display the fact that it is possible to use the reply number. Subsequently, if message sending is selected, the controller unit 110 detects this in step 415 and proceeds to step 416 to send a message containing the authenticated reply number.

The reply number acquiring the authentication grant from the server may be stored in the memory 130, and may be selected and used right away without the above-mentioned authentication procedure.

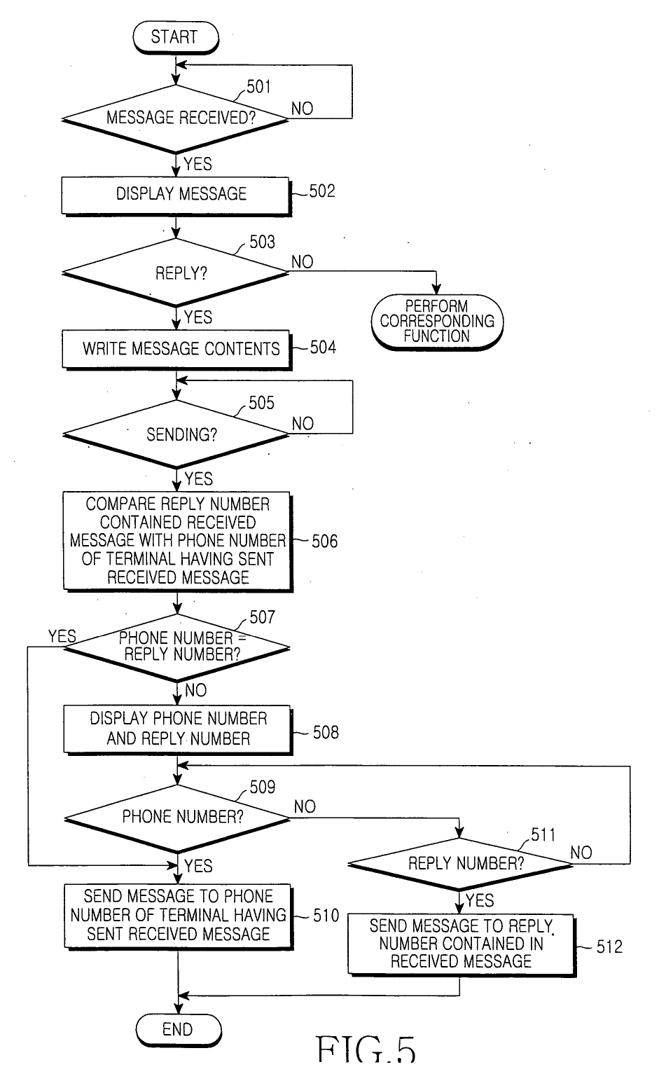

FIG. 5 is flowchart illustrating a procedure of replying to a message in the wireless portable terminal according to the present invention. Referring to FIG. 5, if a message is received by the wireless portable terminal, the controller unit 110 detects this in step 501 and proceeds to step 502 to display the received message. If a reply to the received message is selected, the controller unit 110 detects this in step 503 and proceeds to step 504 to switch the wireless portable terminal to the reply message writing mode. If message sending is selected after completion of writing message contents in the reply message writing mode, the controller unit 110 detects this in step 505 and proceeds to step 506 to extract and compare a reply number contained in the received message and the phone number of a terminal which sent the received message.

If the reply number contained in the received message coincides with the phone number of the terminal, the controller unit 110 detects this in step 507 and sends the reply message to the reply number contained in the received message or the phone number of the terminal.

However, if the reply number contained in the received message does not coincide with the phone number of the terminal, the controller unit detects this in step 507 and proceeds to step 508 to display the reply number contained in the received message and the phone number of the terminal.

If the phone number of the terminal is selected from among the reply number contained in the received message and the phone number of the terminal displayed in step 508, the controller unit 110 detects this in step 509 and proceeds to step 510 to send the reply message to the phone number of the terminal.

If the reply number is selected from among the reply number contained in the received message and the phone number of the terminal displayed in step 508, the controller unit 110 detects this in step 511 and proceeds to step 512 to send the reply message to the reply number contained in the received message.

As described above and as illustrated in FIGS. 4 and 5, only authenticated reply information can be input in the message mode and, if a reply number contained in a received message is different from the phone number of a terminal, which sent the received message, when a reply message to the received message is sent, the reply message may be sent to any one selected from among the reply number and the phone number.

By providing a method for replying to a message in a wireless portable terminal according to the present invention as described above, various types of information other than numerals can be provided as reply information in the message mode of the wireless portable terminal, and the abuse of reply information can be prevented in the message mode of the wireless portable terminal.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for replying to a message in a wireless portable terminal, the method comprising steps of:
inputting reply information utilizing a character set in a message mode of the wireless portable terminal;
converting the input reply information into specific values; and
sending a message containing the reply information consisting of the specific values.

2. The method as claimed in claim 1, wherein the step of converting the input reply information comprises:
converting the character set input as the reply information into corresponding numerals; and
converting the corresponding numerals into specific code values.

3. The method as claimed in claim 2, wherein the corresponding numerals are numerals marked on keys which are pressed in order to input the character set.

4. The method as claimed in claim 2, wherein the specific code values are ASCII code values.

5. The method as claimed in claim 2, wherein the specific code values are HEXA code values.

6. A method for replying to a message in a wireless portable terminal, the method comprising steps of:
if a reply to a received message is selected in the wireless portable terminal, switching the wireless portable terminal to a reply mode;
if sending is selected after message contents are written in the reply mode, analyzing reply information of the received message; and
if the reply information consists of a character set, sending a message to a phone number of a terminal which sent the received message.

7. The method as claimed in claim 6, further comprising:
if the reply information consists of specific values, extracting numerals corresponding to the specific values; and
extracting a character set corresponding to the numerals and displaying the extracted character set as the reply information.

8. The method as claimed in claim 7, wherein the specific values are ASCII code values.

9. The method as claimed in claim 7, wherein the specific values are HEXA code values.

10. The method as claimed in claim 7, further comprising storing the phone number of the terminal which sent the received message and the reply information consisting of the character set.

11. The method as claimed in claim 6, further comprising, if the reply information consists of a reply number, sending the message to the reply number.

12. A method for replying to a message in a wireless portable terminal, the method comprising steps of:
if a reply number is input in a message mode of the wireless portable terminal, requesting that a server authenticate the input reply number; and
if an authentication grant for the reply number is received from the server, sending a message containing the authenticated reply number.

13. The method as claimed in claim 12, further comprising, if a failure to authenticate the reply number is received from the server, displaying information indicating that it is impossible to use the reply number.

14. The method as claimed in claim 12, further comprising:
if the wireless portable terminal requests that the server authenticate the reply, retrieving the reply number by the server;
if the reply number is a phone number of the wireless portable terminal, sending the authentication grant for the reply number from the server to the wireless portable terminal;
if the reply number is not the phone number of the wireless portable terminal, sending a grant-to-use message from the server to a terminal possessing a phone number corresponding to the reply number;
if a grant-to-use response message is received from the terminal possessing the phone number corresponding to the reply number, sending the authentication grant for the reply number from the server to the wireless portable terminal; and
if a response message is not received or a grant-to-use response message is not received from the terminal possessing the phone number corresponding to the reply number, sending a failure to authenticate the reply number to the wireless portable terminal.

15. A method for replying to a message in a wireless portable terminal, the method comprising steps of:
if a reply to a received message is selected in the wireless portable terminal, switching the wireless portable terminal to a reply mode;
if sending is selected after message contents are written in the reply mode, comparing a phone number of a terminal which sent the received message with a reply number contained in the received message; and
if the phone number of the terminal is not the same as the reply number, sending a message to either the phone number of the terminal which sent the received message or to the reply number.

16. The method as claimed in claim 15, wherein the step of sending the message comprises:
if the phone number of the terminal is not the same as the reply number, displaying the reply number contained in the received message and the phone number of the terminal;
if the phone number of the terminal is selected, sending the message to the phone number of the terminal; and
if the reply number is selected, sending the message to the reply number.

17. The method as claimed in claim 15, further comprising, if the phone number of the terminal is the same as the reply number, sending the message to either the phone number of the terminal or the reply number.
